(19) United States
(12) Patent Application Publication
(10) Pub. No.: US 2006/0041665 A1
(43) Pub. Date: Feb. 23, 2006

(54) Network services applications

(76) Inventors: Neeran M. Karnik, New Delhi (IN); Parul A. Mittal, Gurgaon (IN)

Correspondence Address: Frederick W. Gibb, III;McGinn & Gibb, PLLC, Suite 304, 2568-A Riva Road, Annapolis, MD, 21401, US

(21) Appl. No.: 10/855,300

(22) Filed: May 27, 2004

(51) Int. Cl. G06F 15/16

(52) U.S. Cl. 709/228

(57) ABSTRACT

An extensibility mechanism for networked services is disclosed. The service provider can specify the contract for each extension permitted, as part of the web service description. A potential client of the web service can use this description to create customized implementations of the necessary extensions, each conforming to the corresponding contract. Therefore, a service provider offers a plurality of software services. Each service includes a plurality of operations and a plurality of extension points. Each said extension point attaches to an operation, and each operation has zero or more associated extension points. A plurality of requester implementations are stored for respective extension points. When an operation request is received from a requester, a service provider determines if the requested operation has extension points, and if so, invokes a stored implementation of the operation for the respective requester.

### FIELD OF THE INVENTION

The present invention relates to network services applications, and to their reuse. In one non-limiting form, the invention relates to software assets that are based on open web service standards.

### BACKGROUND

Reuse of a software asset requires the ability to locate the relevant asset and determine how to invoke it for the specific need. In component-based software engineering, it is known to provide extension points in reusable assets (components). An extension point allows the functionality of the asset to be customized based on the preferences of the user of the asset. The customization may be done for a plurality of reasons, for example, to improve the execution time of a particular method, to localize the functionality for local language, or to specify an alternate algorithm for a particular task.

Now that web services—one form of network services—are being increasingly used as the preferred mechanism for delivering software functionality over the Internet, a reusability mechanism is desirable, so that web services can be exploited as reusable components in distributed applications.

The typical service oriented architecture (SOA) comprises of a web service provider who offers a web service to be used by a plurality of requesters. The web service is defined by a standard interface, eg. using the Web Services Description Language (WSDL). The requester can invoke the methods in the interface by specifying the name of the web service, the method to be used and appropriate parameters. The invocation can be either remote procedure invocation (RPC) style or message-based. There are standard protocols such as SOAP, which allow the invocation of a web service by a plurality of requesters. The existing architecture does not however allow the provider of the service to specify any extension points of the offered service. This limits the requester of the web service to use the service in the form offered, without any explicit mechanism for customization. Some form of customization can be simulated by means of the parameters passed during service invocation. But it is not possible, for example, to pass a piece of code to be executed as a parameter of the method. Say the offered service provides a method called funk( ). Internally, as part of executing funk( ), the service performs task1, task2 and task3. It would be useful to allow the provider of the service to specify an extension point for, say, task2, and to allow the service requester to provide an implementation of task 2 while invoking funk( ).

The specification of an extension point does not imply that the service requester must necessarily provide an implementation for the extension point, while invoking the service. The service provider could provide a default implementation for the extension point—in this case task2—which is used if a service requester doesn't provide its own implementation. The extension point is an optional mechanism for the service requester to customize the service according to its needs and preferences, while ensuring that the semantics of the service are unaltered.

Component-based software engineering relies on features of object-oriented programming languages to provide customizability. The definition of a component includes a syntactic description of its class, describing the methods (also known as operations or messages) to which it responds, as well as the state variables that it exposes to its clients. A specific client may customize the component for its own use by defining a subclass that is derived from the component's class. The subclass may override some of its parent class' methods, providing its own, customized implementations of those methods.

The use of plug-ins is another common mechanism for customization. A component defines a point in its code at which it invokes a user-supplied plug-in in some well-defined manner (with a known set of parameters, for example). Often the plug-in is specified in the form of an abstract class. Different users of the component can install different plug-ins (concrete classes conforming to the abstract plug-in class), thus customizing the behaviour of the component for their purposes. Also, Clinick (Andrew Clinick “Creating Customizable Web Services”, Microsoft Corp, available at http://msdn.microsoft.com/library/en-us/dnclinic/html/scripting09102001.asp?frame=true) describes how a service provider can create customized versions of web services using a scripting language, to address differing user requirements, incremental upgrades, etc.

The customization of components, as described above, is done statically. That is, a customized version of the component is created and integrated into the application. Its behaviour cannot be changed at runtime. If the requirements change, the component must be re-customized and the application re-compiled and reinstalled. Currently running applications cannot benefit from improvements to the implementation. Secondly, no such mechanism currently exists for web services. Rather than building distributed applications using libraries of components, it is preferable to use web services as components. This would result in looser coupling within the application, and allow parts of the application to be independently maintained, upgraded, etc. without disrupting the overall operation. While web services are based on well-defined open standards, and supported by mature programming tools and environments, these do not allow any dynamic customization by clients.

The technique used in Clinick does not allow service requesters to customize a third-party service provider's web service—it merely allows service providers to create customized versions. It also requires the service provider to use a particular scripting language to create an extension, and to install the script on the original web service. The web service platform must also have a script engine that understands and interprets the scripting language. These requirements may not be acceptable to the service provider, especially for security reasons.

An objective of this invention is to provide the ability to the web service provider to specify the extension points in a web service interface, and to allow the web service requester to extend the web service at its extension points for its specific needs. In this way, software assets are available for reuse.

### SUMMARY

An extensibility mechanism for networked services is provided. The service provider can specify the contract for each extension permitted, as part of the web service description. A potential client of the web service can use this description to create customized implementations of the necessary extensions, each conforming to the corresponding contract.

A service provider offers a plurality of software services. Each service includes a plurality of operations and a plurality of extension points. A plurality of requestor implementations are stored for respective extension points. When an operation request is received from a requester, a service provider determines if the requested operation has an associated extension point, and if so, invokes a stored implementation of the operation for the respective requestor.

A mechanism for ‘installing’ an extension at runtime, thus allowing for dynamic customization, is also provided. This allows extensibility at run-time in a dynamic fashion, without affecting other requesters of the web-service.

### DESCRIPTION OF DRAWINGS

FIG. 1 is a schematic block diagram of a web services environment.

FIG. 2 is a schematic diagram of a web service framework.

FIG. 3 is a flow diagram of a service requestor registering an implementation for an extension point.

FIG. 4 is a flow diagram of a service provider executing an operation with extension points.

FIG. 5 is a schematic representation of a computer system suitable for performing the techniques described herein.

### DETAILED DESCRIPTION

Although the term ‘web service’ is used in describing an embodiment of the invention, it will be understood that the invention applies equally to other forms of networked services, such as the grid services of Open Grid Services architectures.

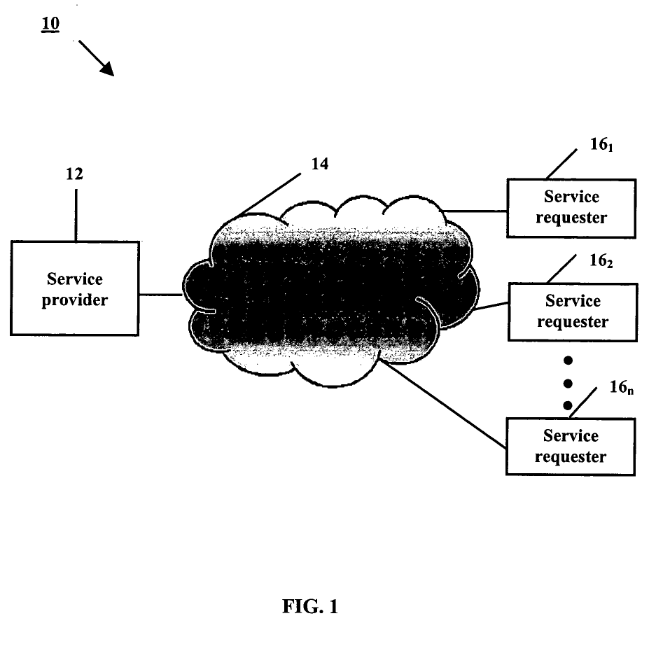

FIG. 1 shows a system 10, which comprises of a service provider 12, a network 14, and a plurality of service requesters 16. The service provider 12 offers a plurality of software services to be used by one or more service requesters 16. “Services” are typically the business functions of an enterprise, or its business partners. They are used to model different kinds of service providers in a consistent way.

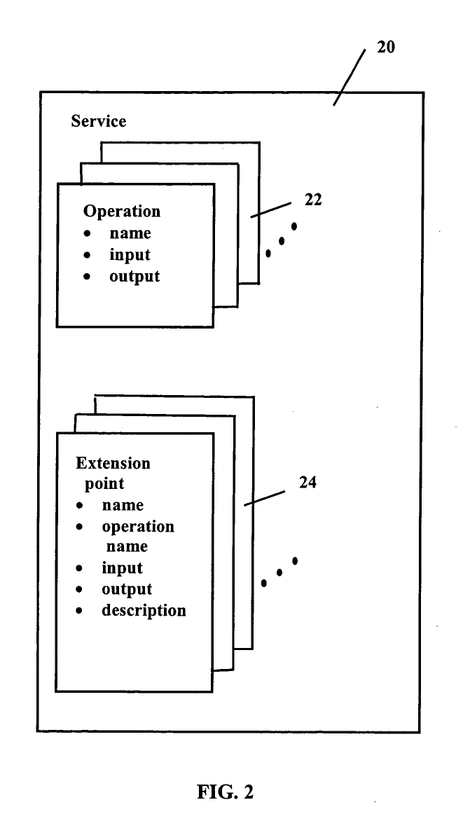

FIG. 2 shows a framework 20 of a service. A service can be described as an interface comprising of one or more operations 22, and a plurality of extension points 24. Operations define the input data needed for the operation and the output data that is the result of the operation. The extension point is a mechanism to allow the functionality of the service to be customized based on the preferences of the service requester. An extension point 24 is specified with respect to an operation 22 described in the service interface. Some operations will have more than one extension point, while other operations will have none. Extension points 24 are explicitly exposed to service requesters for customization. An extension point 24 is specified as a contract comprising of a name, the operation that it belongs to, expected input and output data and a description of the exposed task. A service requester normally will provide the implementation for an extension point 24. The implementation must conform to the extension point's contract.

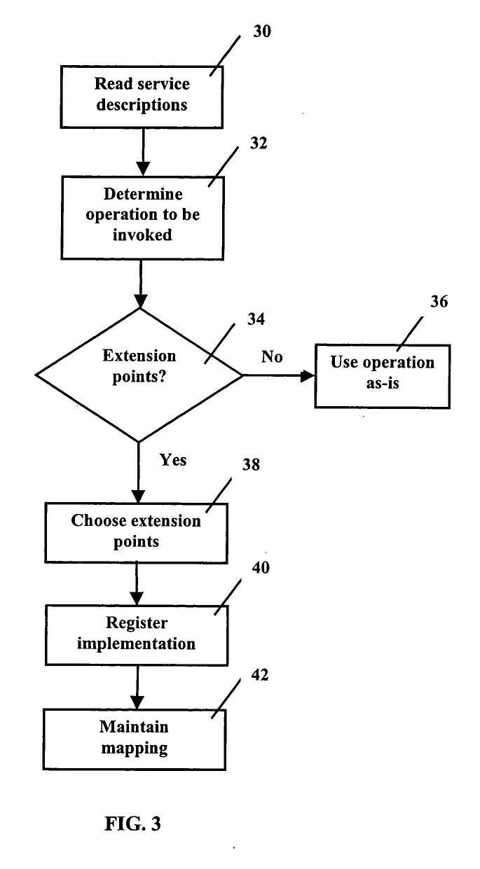

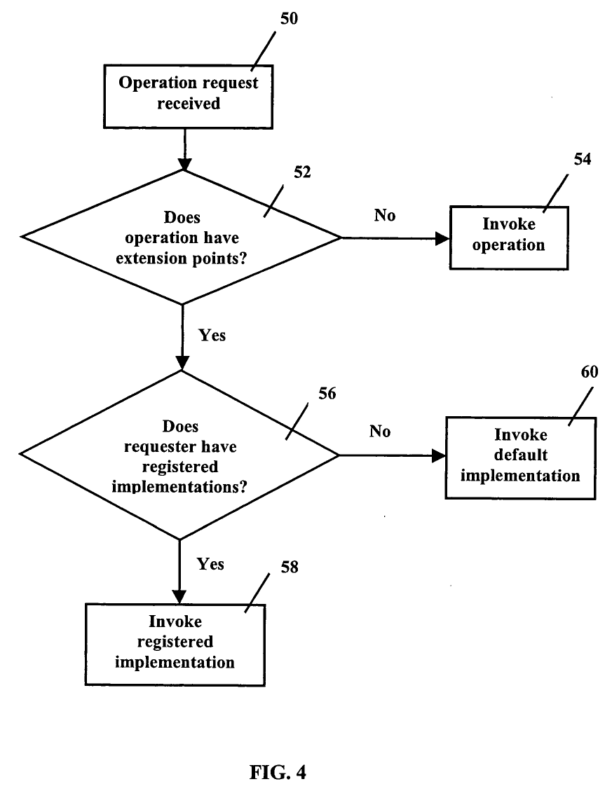

The flowcharts in FIGS. 3 and 4 describe the steps executed by a service requester 16 and the service provider 12, respectively. Considering firstly FIG. 3, the service requester 16 reads the services 20 offered by a service provider 12 (step 30). The steps required by the service requester 16 to locate the services 20 offered by the service provider 12 do not change due to the extension mechanism. Hence the existing protocols such as UDDI can be used. In the case that a requester doesn't wish to specify an extension, the existence of extension points remains transparent to it. Thus, the extensible web service remains compatible with older clients that are unaware of the extension mechanism.

The requester next determines which operation 22 it wishes to invoke (step 32). The requester then determines if the operation it wishes to invoke has any extension points (step 34). If not, then the operation may only be invoked ‘as-is’ (step 36). If so, the requester determines for which one or more extension points it wishes to register an implementation (step 38). To register an implementation for the extension point of a specific operation (step 40), the requester specifies a unique identifier of the extension point, and the information needed to invoke the requester's implementation. The unique extension point identifier could be the extension point name qualified by the names of the operation and service to which the extension point belongs. The information to invoke the requester's implementation could be specified as a fragment of WSDL, describing its location (Uniform Resource Locator) and binding details such as the protocol to be used to access the implementation. The service provider maintains a mapping (eg. using a hash-table data structure) of the registered extension, including the service requester's identifier, the extension point identifier, the location for the implementation and its binding information (step 42). In this way, a service requester registers extension point implementations prior to the actual service usage.

FIG. 4 shows the steps executed by the service provider 12 when an operation 22, which has extension points, is invoked by a service requester 16. As mentioned above, the service provider 12 maintains a mapping for all the extension point implementations, registered by a plurality of service requesters 16 for a plurality of extension points 24. The service provider 12 also maintains a mapping of all its extension points, the corresponding operation and service.

When the service provider receives a request for an operation (step 50), it firstly determines if the operation has extension points (step 52). If not, then the operation is simply invoked (step 54). But if so, it checks whether the current requester has registered implementations for any of the operation's extension points (step 56). If it finds one or more such implementations, then the service provider invokes that implementation during the operation execution (step 58). The invocation of an extension point implementation is done using the location and binding information already registered. For web services, this corresponds to making a SOAP call using the particular binding (eg. HTTP or JMS or SMTP) and URL specified during registration. Otherwise, the default implementation of the extension point, provided by the service provider is used (step 60). This enables different service requesters to customize an extension point according to their respective preferences, and not interfere with the service offered to other service requesters.

### Other Embodiments

In another embodiment, the registration of the extension point implementation could be done dynamically at the time of using the service, rather than prior to service usage as described above. The dynamic registration can be done by including a flag parameter in the operation invocation to indicate that a dynamic extension is being done, the extension point identifier(s), and the implementation information. Another flag can indicate whether this extension should apply only to the current invocation (a one-time extension), or to all subsequent invocations (a persistent extension).

When the service provider 12 receives such a dynamic registration, it first stores information such as the requester identifier and extension point implementations being registered, in the appropriate mapping as discussed above. Then the flowchart of FIG. 4 is executed. If this was a one-time extension, the registration is deleted after the invocation completes. Otherwise, the registration replaces any existing extension, and will be reused during subsequent invocations by the same service requester 16.

In yet another embodiment, if an operation has multiple extension points and the requester has previously registered implementations for more than one extension point, then the requester can specify which specific extensions it wishes to be used during a specific operation invocation. This can be done by means of an operation parameter that lists the extension point identifiers for which the registered implementations are to be used. The requester can also specify that it wishes to use none of the registered implementations by passing a null value for that parameter during operation invocation. This would apply to both static and dynamic (persistent) registrations. This allows the service requester to customize the operation in multiple ways to suit its needs at different times.

In yet another embodiment, the registration of an extension point implementation may involve deploying the implementation code onto the service provider 12. The implementation information still includes the location and binding information, but the implementation resides on the service provider's local server.

In yet another embodiment, the entity registering the extension point implementation, ie. the extender, is not the same as the service requester. The extender could represent a group of service requesters, where any service requester belonging to the group can use the implementations registered by the extender. A group identifier can be used to register the extension point implementations, and can be further used by the service requesters while invoking the extensions. Access control may be provided to ensure that only the extender can register implementations and service requesters can only use them.

In yet another embodiment, the extension point specification also consists of fault messages generated during the execution of the logic implementing the extension.

In yet another embodiment, the extension point contract consists of a formal semantic description of the expected logic that implements the extension.

In yet another embodiment of the present invention, the service invocation can be synchronous or asynchronous in nature.

Computer Hardware

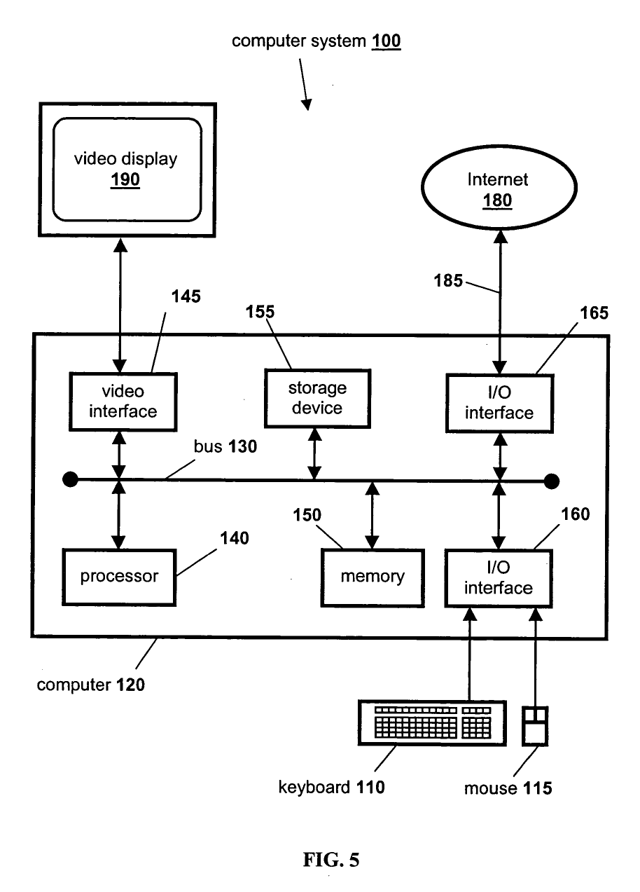

FIG. 5 is a schematic representation of a computer system 100 of a type that is suitable for executing computer software for embodying the methods performed by the service provider 12 described above. Computer software executes under a suitable operating system installed on the computer system 100, and may be thought of as comprising various software code means for achieving particular steps.

The components of the computer system 100 include a computer 120, a keyboard 110 and mouse 115, and a video display 190. The computer 120 includes a processor 140, a memory 150, input/output (1/O) interfaces 160, 165, a video interface 145, and a storage device 155.

The processor 140 is a central processing unit (CPU) that executes the operating system and the computer software executing under the operating system. The memory 150 includes random access memory (RAM) and read-only memory (ROM), and is used under direction of the processor 140.

The video interface 145 is connected to video display 190 and provides video signals for display on the video display 190. User input to operate the computer 120 is provided from the keyboard 110 and mouse 115. The storage device 155 can include a disk drive or any other suitable storage medium.

Each of the components of the computer 120 is connected to an internal bus 130 that includes data, address, and control buses, to allow components of the computer 120 to communicate with each other via the bus 130.

The computer system 100 can be connected to one or more other similar computers via a input/output (I/O) interface 165 using a communication channel 185 to a network, represented as the Internet 180.

The computer software may be recorded on a portable storage medium, in which case, the computer software program is accessed by the computer system 100 from the storage device 155. Alternatively, the computer software can be accessed directly from the Internet 180 by the computer 120. In either case, a user can interact with the computer system 100 using the keyboard 110 and mouse 115 to operate the programmed computer software executing on the computer 120.

Other configurations or types of computer systems can be equally well used to execute computer software that assists in implementing the techniques described herein.

### CONCLUSION

Various alterations and modifications can be made to the techniques and arrangements described herein, as would be apparent to one skilled in the relevant art.

1. A method for serving network applications said method comprising:
offering, using a service provider, a plurality of software services, each said service including a plurality of operations and a plurality of extension points;
storing a plurality of requester implementations for respective extension points;
receiving an operation request from a requester;
said service provider determining, using said service provider, if said requested operation has at least one associated extension point; and
if said requested operation has at least one associated extension point, invoking a requester-specified stored implementation of said operation for the respective requester.

2. The method of claim 1, further comprising invoking said requested operation if there are no extension points associated with said requested operation.

3. The method of claim 1, further comprising invoking a default implementation if there are no registered implementations for said requested operation.

4. The method of claim 1, further comprising invoking said requested operation if there are no associated extension points for the requester.

5. A method for serving network applications said method comprising:
offering, using a service provider, a plurality of software services, each said service including a plurality of operations and a plurality of extension points;
receiving an operation request from a requester;
determining, using said service provider, if said requested operation has at least one associated extension point; and
if said requested operation has at least one associated extension point, said requester causing installation of an implementation on said provider, and said provider invoking said installed implementation of said operation for the respective requester.

6. The method of claim 5, further comprising invoking said requested operation if there are no extension points associated with said requested operation.

7. The method of claim 5, further comprising invoking a default implementation if there are no registered implementations for said requested operation.

8. A network services software framework comprising:
a plurality of operations;
a plurality of extension points, each said extension point attaching to said operation; and
a plurality of requester implementations for one or more said extension points.

9. The framework of claim 8, further including a default implementation to be invoked for extension points not having a registered requester implementation.

10. The framework of claim 8, wherein an extension point includes a name, the operation to which it belongs, expected input data, expected output data, and a description of an exposed task.

11. A network services provider server including a plurality of software service frameworks comprising a plurality of operations, a plurality of extension points, each said extension point attaching to said operation, and a plurality of registered requester implementations for one or more said extension points.

12. The server of claim 11, further comprising a default implementation to be invoked for extension points not having a registered requester implementation.

13. The server of claim 11, wherein an extension point includes a name, the operation to which it belongs, expected input data, expected output data, and a description of an exposed task.

14. A network services system comprising:
a plurality of service requesters;
a network to which said requesters connect; and
a plurality of service providers also connected to said network;
wherein said service providers offers a plurality of software services to said requesters, each said service including a plurality of operations and a plurality of extension points, and said providers store a plurality of implementations for respective extension points provided by said requesters;
and wherein, when a service provider receives a operation request from a requester, said service provider determines if said requested operation has at least one associated extension point, and if so, invokes a requester-specified stored implementation of said operation for the respective requester.

15. The system of claim 14, wherein said service provider invokes said requested operation if there are no extension points associated with the requested operation.

16. The system of claim 14, wherein a said service provider invokes a default implementation if there are no registered implementations for said requested operation.

17. A network services system comprising:
a plurality of service requesters;
a network to which said requesters connect; and
a plurality of service providers also connected to said network;
wherein a service provider offers a plurality of software services, each said service including a plurality of operations and a plurality of extension points;
and wherein, when a service requester requests an operation from a service provider, said service provider determines if said requested operation has at least one extension point, and if so, said requestor causing installation of an implementation on said provider, and said provider invokes said installed implementation of said operation for the respective requester.

18. The system of claim 17, wherein said service provider invokes said requested operation if there are no extension points associated with the requested operation.

19. The system of claim 17, wherein said service provider invokes a default implementation if there are no registered implementations for said requested operation.

20. A computer program product comprising a computer program stored on a computer readable medium, said computer program including:
code means for offering a plurality of software services, each said service including a plurality of operations and a plurality of extension points; code means for storing a plurality of requester implementations for respective extension points;
code means for receiving an operation request from a requester; and
code means for determining if said requested operation has at least one associated extension point, and if se said requested operation has at least one associated extension point, code means for invoking a requester-specified stored implementation of said operation for the respective requester.

21. A computer program product comprising a computer program stored on a computer readable medium, said computer program including:
code means for offering a plurality of software services, each said service including a plurality of operations and a plurality of extension points;
code means for receiving an operation request from a requester; and
code means for determining if said requested operation has at least one associated extension point, and if said requested operation has at least one associated extension point code means for causing installation of an implementation on said provider, and invoking said installed implementation of said operation for the respective requester.

22. A method for reusing software applications, said applications having a plurality of operations, comprising:
attaching one or more extension points to one or more said operations;
associating a service requester implementation with one or more said extension points; and
invoking said implementation, if registered, in response to a service request for said extension point.

23. The method of claim 22, further comprising invoking said requested operation if there are no extension points.

24. The method of claim 22, further comprising invoking a default implementation if there are no registered implementations for said requested operation.

25. A network services method comprising:
a service provider offering a plurality of software services, each said service including a plurality of operations and a plurality of extension points; and
a requester specifying an implementation for said extension point associated with said operation.

26. The method of claim 25, further comprising said service provider storing said specified implementation.

27. A service requester apparatus for a web services environment in which a service provider offers a plurality of software services, each said service including a plurality of operations and a plurality of extension points, said apparatus comprising:
means for providing an implementation of an operation relating to an extension point associated with said operation; and
means for requesting said operation invocation.
